(19) United States
(12) Patent Application Publication
(10) Pub. No.: US 2008/0120419 A1
(43) Pub. Date: May 22, 2008

(54) Transparent Global Computer Communication Network

(76) Inventors: David Charles Yamartino, Yona, GU (US); Masood Namazi Mohammad Abadi, Barrigada, GU (US)

Correspondence Address: DAVID YAMARTINO, P.O. BOX 326033, HAGATNA, GU, 96932, omitted

(21) Appl. No.: 11/277,043

(22) Filed: Mar. 21, 2006

(51) Int. Cl. G06F 15/16

(52) U.S. Cl. 709/229

(57) ABSTRACT

A computer implemented method, system, and computer usable program code for a transparent global computer communication network. A published public source is used to confirm that an organization requests access-enabling information. In response to confirming that the organization requests access-enabling information, the access-enabling information is sent to the organization. The access-enabling information is used to verify that an organization member requests access to the computer communication network. In response to verifying that the organization member requests access to the computer communication network, a communication is received from the organization member. A name of the organization member is displayed with the communication from the organization member on the computer communication network.

### BACKGROUND OF THE INVENTION

1. Field of the Invention

The present invention relates generally to an improved data processing system and in particular to a computer implemented method, system, and computer usable program code for optimizing performance in a data processing system. Still more particularly, the present invention provides a computer implemented method, system, and computer usable program code for a transparent global computer communication network.

2. Description of the Related Background Art

A communication network is a system capable of providing information transfer between persons and equipment. Such a system usually consists of a collection of individual communication systems, transmission systems, relay stations, tributary stations, and terminal equipment capable of interconnection and interoperation so as to form an integrated whole. These individual components serve a common purpose, are technically compatible, employ common procedures, respond to some form of control, generally operate in unison, and may include or use computers. A computer communication network may be classified according to its geographical extent, such as a local area network (LAN), a metropolitan area network (MAN), and a wide area network (WAN).

Sets of interconnected computer communication networks, such as the Internet, provide humanity with a means of global communication that is generally freed from regional and national restrictions. The reach, speed and functionality of the Internet continue to increase as existing technologies are improved and new technologies are integrated into global communication. The Internet offers many methods of interactive interpersonal communication, including instant messenger services, chat rooms, electronic mail, discussion groups, and forums. Collectively, these and other methods of interactive interpersonal communication may comprise a computer communication network.

A computer communication network can have a wide range of applications. Some examples of applications for a computer communication network include commercial computer communication networks, government computer communication networks, literary computer communication networks, artistic computer communication networks, and scientific computer communication networks. An illustrative embodiment of a computer communication network in accordance with the present invention is an educational computer communication network comprised of students and schools.

Although there is no lack of means of communication available to educators and students worldwide, none of these currently available means have formed the basis of a global educational computer communication network allowing free interaction between students and schools from around the world. A wide area computer communication network with a global extent is a global computer communication network. One barrier that prevents the formation of such a global educational computer communication network is that the methods of communication available via computer communication networks, such as the Internet, generally allow a user to conceal her identity. Users can generally communicate under whatever name or alias they choose. Therefore, educational users—both students and educators—cannot fully trust that the means of communications currently available to them via existing computer communication networks, such as the Internet, will be free from deceptive or manipulative influences. Lack of trust in the integrity of a potential global educational computer communication network therefore prevents the formation of a realized global educational computer communication network. Because of the general lack of transparency in communications, such as Internet communications, no natural gravitation towards any of the current means of Internet communication exists as the basis of a global educational computer communication network.

Although the electronic infrastructure that could connect students and schools worldwide in a global computer communication network currently exists, no such network yet exists. Among the many means of communication, there are none available that appeal sufficiently to educators as a basis for such a global educational computer communication network. The lack of network activity feedback to users and the lack of controls to ensure both student safety and proper use of a global educational computer communication network prevent the establishment of a global educational computer communication network based on the existing electronic infrastructure.

### SUMMARY OF THE INVENTION

Embodiments of the present invention provide a computer implemented method, system, and computer usable program code for a transparent global computer communication network. A published public source is used to confirm that an organization requests access-enabling information. In response to confirming that the organization requests access-enabling information, the access-enabling information is sent to the organization. The access-enabling information is used to verify that an organization member requests access to the computer communication network. In response to verifying that the organization member requests access to the computer communication network, a communication is received from the organization member. A name of the organization member is displayed with the communication from the organization member on the computer communication network.

### BRIEF DESCRIPTION OF THE DRAWINGS

The novel features believed characteristic of the invention are set forth in the appended claims. The invention itself, however, as well as an illustrative mode of use, further objectives and advantages thereof, will best be understood by reference to the following detailed description of an illustrative embodiment when read in conjunction with the accompanying drawings, wherein:

FIG. 1 is a pictorial representation of a data processing system in accordance with an illustrative embodiment of the present invention;

FIG. 2 is a block diagram of a data processing system that may be implemented as a server in accordance with an illustrative embodiment of the present invention;

FIG. 3 is a block diagram of components that may be used to implement a transparent global computer communication network in accordance with an illustrative embodiment of the present invention;

FIG. 4 is a pictorial representation illustrating a typical network map displaying two methods of area selection in accordance with an illustrative embodiment of the present invention;

FIG. 5 is a pictorial representation illustrating a typical client login window in accordance with an illustrative embodiment of the present invention;

FIG. 6 is a pictorial representation illustrating a typical communicate window in accordance with an illustrative embodiment of the present invention;

FIG. 7 is a pictorial representation illustrating a typical network map displaying various information in accordance with an illustrative embodiment of the present invention;

FIG. 8 is a pictorial representation illustrating a typical questions window in accordance with an illustrative embodiment of the present invention;

FIG. 9 is a pictorial representation illustrating a typical virtues window in accordance with an illustrative embodiment of the present invention;

FIG. 10 is a pictorial representation illustrating a typical service window in accordance with an illustrative embodiment of the present invention;

FIG. 11 is a pictorial representation illustrating a typical games window in accordance with an illustrative embodiment of the present invention;

FIG. 12 is a pictorial representation illustrating a typical network map displaying an animation feature in accordance with an illustrative embodiment of the present invention;

FIG. 13 is a pictorial representation illustrating a typical journal window in accordance with an illustrative embodiment of the present invention;

FIG. 14 is a pictorial representation illustrating a typical special window in accordance with an illustrative embodiment of the present invention; and

FIG. 15 is a flow chart illustrating a typical network process in accordance with an illustrative embodiment of the present invention.

### DETAILED DESCRIPTION OF THE PREFERRED EMBODIMENT

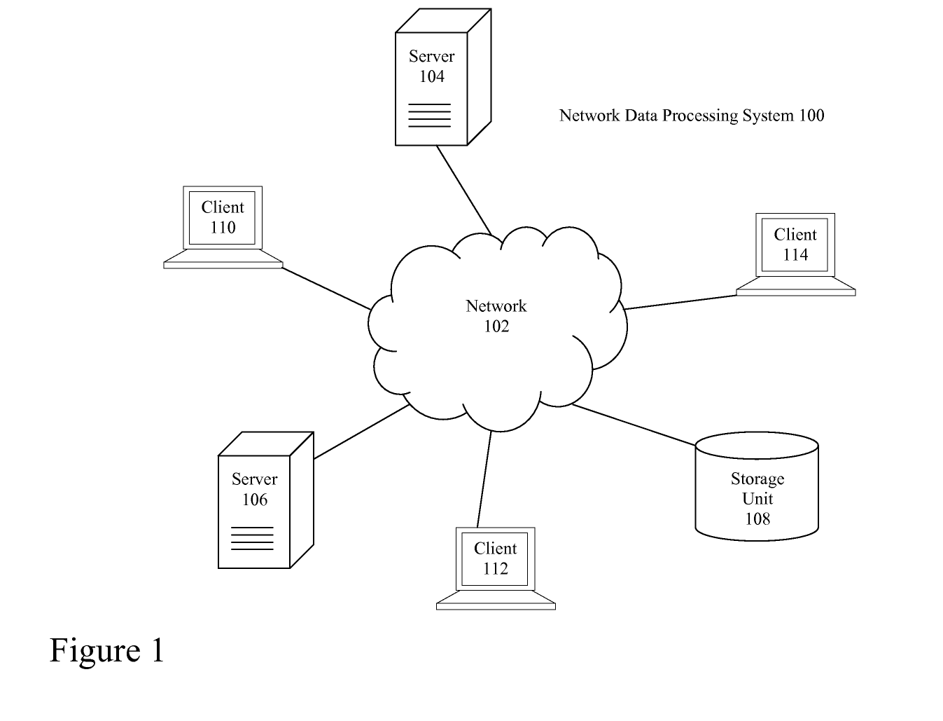

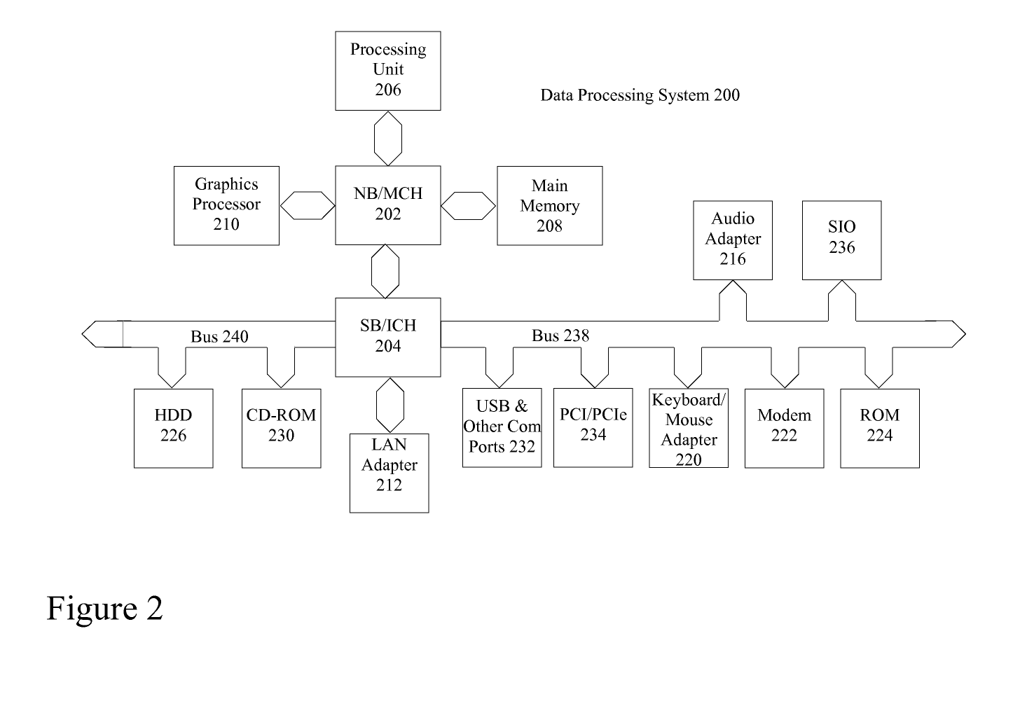

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204 through bus 238.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more busses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or LAN adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Illustrative embodiments of the present invention provide the required controls, self-regulating features, confirmation, verification and transparency required to enable users of a computer communication network to enter into a transparent global computer communication network with confidence in the security and proper use of such a network. A user interface of a computer communication network is the graphical, textual and auditory information presented to a user of a computer communication network, and the control sequences (such as keystrokes with a computer keyboard, movements of a computer mouse, and selections with a touchscreen, voice activation, or an optical selector) the user employs to respond to the interface. Currently the types of user interfaces that are the most common include graphical user interfaces and web-based interfaces. A graphical user interface accepts input via devices, such as a computer keyboard and a computer mouse, and provides articulated graphical output on a computer display, which may be connected to a computer communication network, such as the Internet. A web-based interface accepts input via similar input devices and provides output on a computer display by generating web pages which are transported via a computer communication network, such as the Internet, and viewed by a user using a web browser program.

Users, including organizations and individuals, who are not yet on a list of registered users with a transparent global computer communication network are not able to communicate with registered users via a user interface for the computer communication network. However, unregistered users are able to view network demonstrations and access some network information. An organization that accesses a registration form for a transparent global computer communication network can request registration through a user interface to become part of the transparent global computer communication network. An organization may be a business, an educational institution, a non-profit body, an enterprise, or some other group of people that participate in an activity together. A transparent global computer communication network server receives registration requests from user interfaces and prompts a transparent global computer communication network server to verify an organization for registration. Registered organizations enable individual members of the organization to register with the transparent global computer communication network, whereby the registered individual members gain full access to network activities and resources. An organization member is one person of a group of people who participate in an activity together.

Besides the unregistered users, students and school administrators, there are two other groups of people who may be able to participate in such a computer communication network. Parents of students may want to audit a transparent global educational computer communication network for their children's school. Parents may be authorized by the school administrator to monitor network activity, but parents may not communicate, etc. Also, state or district educational system administrators and personnel may also be able to monitor network activity.

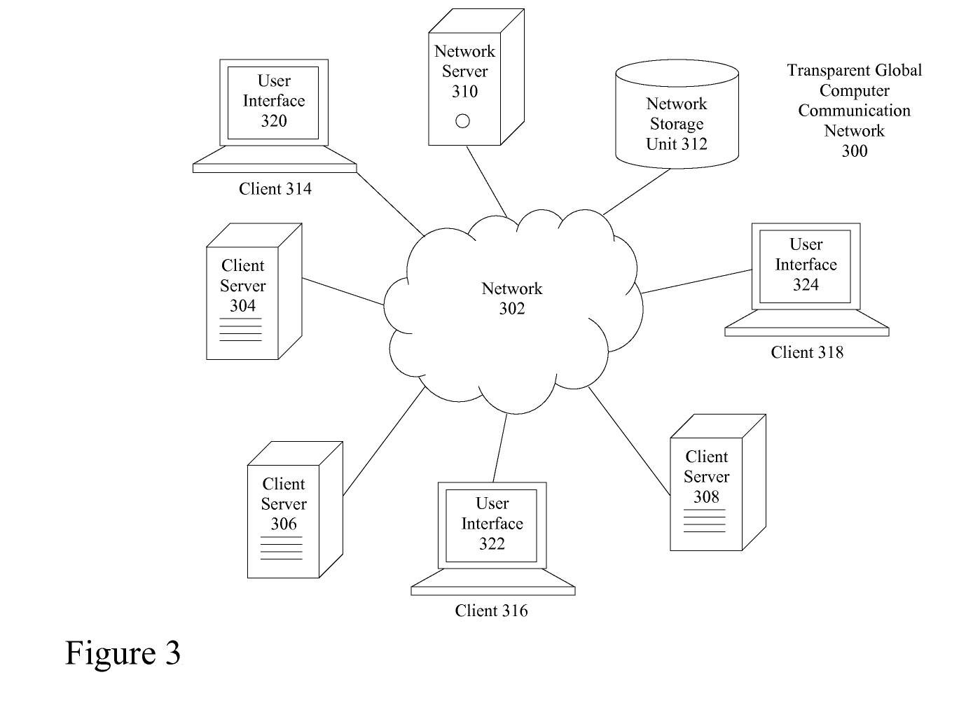

FIG. 3 is a block diagram of components that may be used to implement a transparent global computer communication network in accordance with an illustrative embodiment of the present invention. Illustrative embodiments of the present invention may be implemented using components of the network for the data processing system in FIG. 1, such as server 104 or storage 108. These embodiments may be implemented to serve the users of a network such as network 102 for the data processing system in FIG. 1, such as client 110, client 112, or client 114. In the depicted example, transparent global computer communication network 300 contains network 302, which is the medium used to provide communication links between various devices and computers connected together within transparent global computer communication network 300. Client servers 304, 306, and 308, network server 310, and network storage unit 312 connect to network 302. In addition, registered users use clients 314, 316, and 318 to connect to network 302 via user interfaces 320, 322, and 324, respectively. Client servers 304, 306, and 308, and network server 310 may be the same as servers 104 and 106 in FIG. 1. Clients 314, 316, and 318 may be the same as clients 110, 112, and 114 in FIG. 1. Network storage unit 310 may be the same as storage unit 108 in FIG. 1. A network administrator may use network server 310 and network storage unit 312 to administer network 302. Transparent global computer communication network 300 may include additional servers, clients, and other devices not shown. FIG. 3 is intended as an example, and not as an architectural limitation for different embodiments of the present invention.

As an illustrative example of a transparent global computer communication network, a transparent global educational computer communication network operates through sets of interconnected communication networks, such as the Internet, to create a global network of schools that authorize students and administrators to connect directly to the transparent global educational computer communication network server for peer-to-peer communication. In an illustrative example of registration for an organization in a transparent global educational computer communication network, a school administrator initiates a school registration process.

The school administrator accesses a standard request form for access-enabling information for a transparent global educational computer communication network and completes the standard request form for access-enabling information requiring input of various identifying information, such as administrator name and title, and school name and location. Access enabling information is knowledge and data that provide a means to use a computer communication network. A request for access-enabling information is a formal message expressing the desire to obtain the knowledge and data that provide the means to use the computer communication network.

However, the school administrator does not provide contact information used for verification. In response to receipt by the user interface of the identifying information submitted by the school administrator, the user interface transmits the request for access-enabling information to a transparent global educational computer communication network server. Then the transparent global educational computer communication network server accesses a transparent global educational computer communication network database to obtain school contact information for the school from published public sources. A published public source is a distributed accessible reference that includes contact information. The transparent global educational computer communication network server contacts the school administrator by using this public contact information in order to confirm that the school administrator initiates the registration request. Upon receipt of this confirmation, the transparent global educational computer communication network registers the school via the transparent global educational computer communication network server. Alternatively, the transparent global educational computer communication network server contacts the school administrator by using public contact information to offer an opportunity for the school administrator to initiate a registration request before using published public sources to confirm that the school administrator initiates the registration request.

Then the transparent global educational computer communication network server sends access-enabling information, school identification characters and a school password, to the school administrator that enables the school administrator to have access to the transparent global educational computer communication network to complete a school profile form. The school profile includes information such as the name of the school, the number of students enrolled in the school, the school's geographic location (city, province, country, longitude, latitude, and altitude), the primary language of instruction, the languages that are spoken in the community, the foreign languages studied at the school, the course titles, and an option to post a school photograph, etc. The school profile is submitted via the user interface to the transparent global educational computer communication network server. The school profile is public and can be accessed by any registered user on the transparent global educational computer communication network.

The school administrator also uses the user interface to submit a list of names of students attending the school and the names of other administrators for the school. Other administrators may include teachers and administrative staff for the school. This list of names of students and administrators is the means that the transparent global educational computer communication network server uses to authorize students and other administrators to fully access network activities and resources. The school administrator can revise this list of names of students and administrators at any time by adding, deleting, or modifying names of students and other administrators. Upon receipt of a list of names of students and administrators, the transparent global educational computer communication network server processes the list of names of students and administrators and adjusts the list of registered users accordingly.

As an illustrative example of registration for an individual, when the school administrator inputs a list of names of students through the user interface, the transparent global educational computer communication network server generates access-enabling information, student identification characters and a temporary student password, for each name listed in the list of names of students, and sends these student identification characters and temporary student passwords to the school administrator via the user interface. The school administrator provides student identification characters and a temporary student password to each student whose name is listed in the list of names of students. Each student uses her own student identification characters and temporary student password to access the transparent global educational computer communication network via the user interface. When an individual student logs in to the transparent global educational computer communication network, she inputs her individual student identification characters and temporary individual student password. The individual student has the option to change the temporary individual student password, which is known by the school administrator, to an individual student password, which is known only to the individual student. Although access to the transparent global educational computer communication network is available through computers located at a registered school, users, both students and administrators, may access the transparent global educational computer communication network via the user interface by using computers located away from the school campus.

Transparent communication through a global network provides school administrators and students with an open but secure school-based student-centered environment in which to communicate and collaborate for various educational purposes. Transparency is a sense of openness and lack of secrecy, a universal self-regulating quality of human interactions that by itself provides a measure of moderation for human behavior. Transparency includes concepts associated with a transparent global computer communication network, including user identity, user communication, and user location.

In regard to user identity, transparency means that a transparent global computer communication network server displays a user's family and given names with all communications and other interactions by a user within a transparent global computer communication network. There are no screen names, aliases, or other devices that hide a user's identity. In regard to user communication, transparency means that all communications within a transparent global computer communication network by a user are available for search and retrieval by other users. There is no private chat within a transparent global computer communication network. In regard to user location, transparency means that a transparent global computer communication network server displays the organization profile of a user's organization with all communications by the user, where the organizational profile may include information such as a name and a geographic location for the organization that is displayed by the user interface. A transparent global computer communication network is location-synchronous, such that a user's displayed geographic location is actual and not subject to manipulation.

Within a transparent global computer communication network, a user cannot hide who they are, what they say, their organization or their organization's location. All of this information is fully transparent. Transparency within a transparent global educational computer communication network provides confidence to users, such as students, administrators, and parents of students, that participation in transparent global educational computer communication network activities will not subject students to deceptive or manipulative influences. Transparency within communications also serves to moderate extreme or offensive language, and to enhance the overall decorum of student interactions. Establishing a secure basis for a fully transparent network encourages greater participation on the part of students and schools, thus increasing the scope of resources available to users registered with a transparent global educational computer communication network.

Although transparency provides a measure of network security, administrative controls are also required to ensure network security. A transparent global educational computer communication network administrator has the authority to allow or disallow any school's participation in the network by specifying such in a communication to a transparent global educational computer communication network server. School administrators have the authority to allow or disallow any student's participation in the network by specifying such via a user interface using the list of students. Additionally, the school administrator can use a user interface to impose certain restrictions on student communication. For example, an administrator of a primary school may restrict student communications for that school to communications with other primary schools only.

Displaying on a transparent global educational computer communication network may be implemented by the displaying of a transparent global educational computer communication network map. An illustrative embodiment of such a network map is a three dimensional globe. The network map provides visual feedback, feature access, and geo-spatial computational capabilities for all communications, activities, objects, and games, etc., associated with a transparent global educational computer communication network. When a registered user accesses a transparent global educational computer communication network, the network map provides visual information regarding various network activity statuses.

Illustrative examples of various network statuses may include the number and location of schools registered to the network, the number and location of schools whose students are currently connected to the network, the number and location of various categories of schools connected to the network (such as elementary schools, high schools, and universities), the number and location of schools communicating in various languages (such as English, Spanish, and French), the number and location of schools communicating on various subjects (such as history, mathematics, and physics), the number and location of schools communicating with one another (showing lines connecting communicating schools), the number of students registered to the network, and the number of students connected to the network. When a user logs in to access the transparent global educational computer communication network, the users interface displays a network map with the latest transparent global educational computer communication network statuses and the user interface initiates communication protocols. A registered user may then log in to access network activities and resources. The network map displays a representation for each school registered to the network. A set of display filters can alter the information presented by the network map. For example, a student can display which schools are currently connected, which are communicating in English, Spanish, etc., which are consulting on certain subjects, such as mathematics, world history, etc., which schools are large, small, etc., which schools are elementary, college, etc., which schools registered to the network within the last 24 hours, one week, one month, etc. The student may rotate or zoom on the network map to provide the appropriate viewing area for the student's current activity.

In an illustrative embodiment of the present invention, the default appearance of a network map is that of the earth as viewed from space using satellite imagery. However, other network map overlays can alter the appearance of the network map. Illustrative examples of overlays may include a natural overlay (satellite imagery), a day-night overlay (displays light and dark parts of the earth), a political overlay (displays country outlines, cities, etc.), a population overlay (displays population densities through color-coding), a temperature overlay (displays average temperatures through color-coding), an agriculture overlay (displays agricultural production and soil types through color-coding), a history overlay (displays a political map of the world at some time in history—for example 1000 years ago), a biology overlay (displays species distribution or migration), a geology overlay (displays specified geological characteristics), a current event overlay (displays a current event such a natural event or human activity), a solid overlay (displays oceans as one solid color and continents as another solid color), and a bubble overlay (displays the earth as transparent, whereby all schools are always visible).

In addition to acting as a display for different types of information, a network map is a communications interface. A communication may include video messages, voice messages, text messages, and graphics messages. A message target (a target is the recipients of a communication) can be selected directly from a computer communication network map. For example, if a student wants to send a message to a group of schools, the student can select a location on the network map to access various options. Such options may include allowing the student to specify the geographic destination for the message, such as the world, a hemisphere, a continent, a country, a state or province, or a city or town. Using this illustrative example, if the student selects a country as the message target, then the student's message is sent to all schools within that country. In another illustrative example, if a student selects to send a message to a specific school, the student may have the options of specifying the grade level, students studying a specific subject, or even a specific student at the specified school. Using this illustrative example, if the student selects “algebra” for the message target, then the message is sent to all students within an algebra class at the specified school.

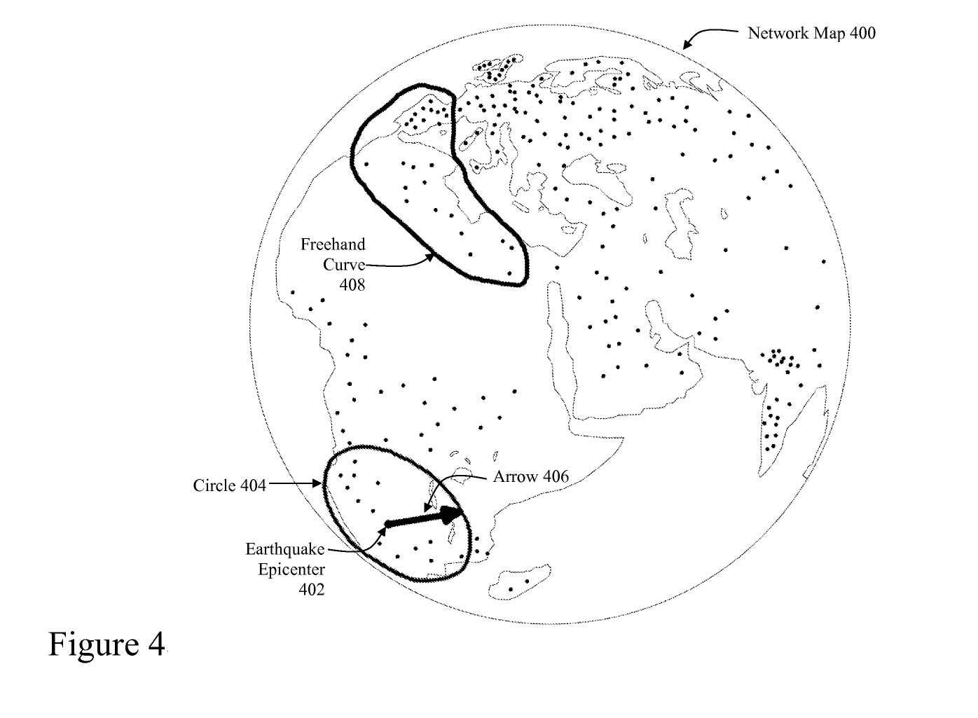

FIG. 4 is a pictorial representation illustrating a typical network map displaying two methods of area selection in accordance with an illustrative embodiment of the present invention. In FIG. 4, registered schools in the transparent global educational computer communication network are represented as points on network map 400. A user interface, such as user interfaces 320, 322, and 324 in FIG. 3, may use a client server, such as client servers 304, 306, and 308 in FIG. 3, to display network map 400. In addition to the methods of message target selection from the previous illustrative examples, a student may select a target for their message through an area selection of network map 400. In an illustrative embodiment of area selection, a student clicks a mouse when a cursor is at a specific location of the network map, and then the student drags the curser over the selected area of the network map. Although this illustrative example uses a mouse for selecting a target for a message, the selection method may include any other selection method, such as a text cursor, voice activation, a touch screen, or an optical selector. For example, if a student wants to send a message to students at all schools within the vicinity of the epicenter of an earthquake event, the student clicks on earthquake epicenter 402 and drags the cursor away from epicenter 402. As the student drags the cursor, circle 404 forms with arrow 406 indicating the radius of the circle. The student may enter the text “25 Km” (if the desired radius is 25 kilometers) or the student may simply select the circle radius by sight. After the students draws circle 404, network map 400 displays a summary of information regarding the schools that are located within the circle, such as the number of schools and the numbers of students. Then the student that draws circle 404 may send a message to the selected schools within circle 404. A student may also select a group of schools as a message target by drawing freehand curve 408 that encloses the region desired as the message target. Then the student that draws freehand curve 408 may send a message to the selected schools within freehand curve 408.

Additionally, a network map may offer other geo-spatial computational functions available to a student. An illustrative example of a geo-spatial computational function available to a student is the capability for doing research on the relationship of geography to language development. To conduct this research, the student may draw a freehand curve around a mountain range, selecting all the schools in the area. From the area selected, the student may make inquiries of the network map to determine information such as the number of square kilometers represented by the area of the freehand curve, the languages of instruction used at the schools within the freehand curve, the languages spoken in the communities represented by these schools within the freehand curve, and the altitude range of the schools within the freehand curve. The student may select filters for the network map in order to filter the display of schools to indicate which schools have a certain language of instruction, which schools have communities who speak a certain language, etc. The student may perform similar inquiries of other areas in the world, such as selecting mountain ranges, rivers, island groups, etc.

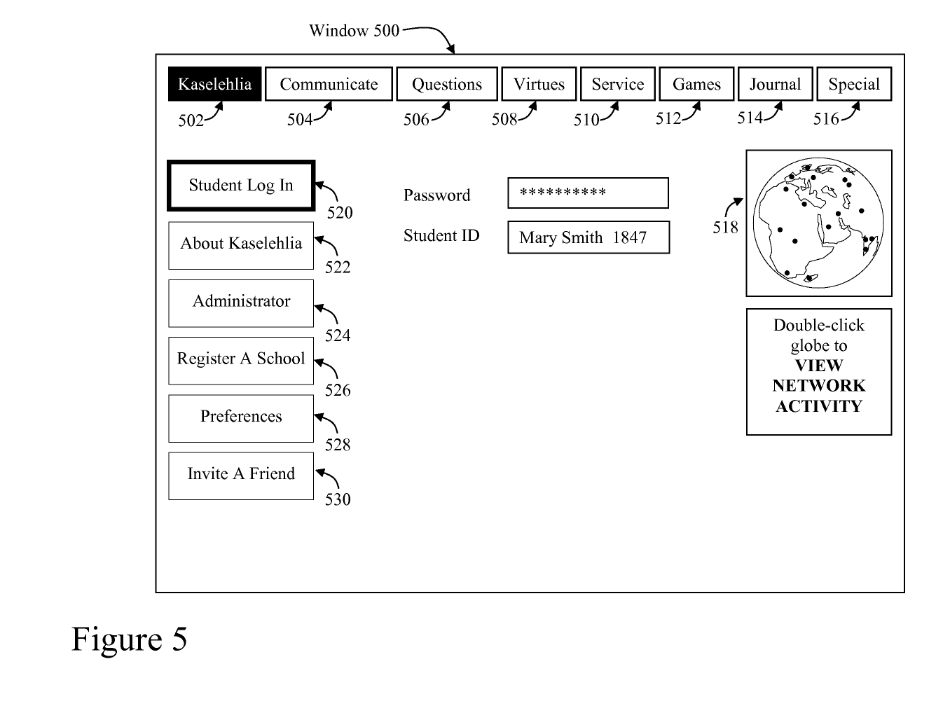

FIG. 5 is a pictorial representation illustrating a typical client software login window in accordance with an illustrative embodiment of the present invention. A user interface, such as user interfaces 320, 322, and 324 in FIG. 3, may use a client server, such as client servers 304, 306, and 308 in FIG. 3, to display window 500. In the illustrative example of FIG. 5, the transparent global educational computer communication network has the name “Kaselehlia.” Window 500 has tabs Kaselehlia 502, Communicate 504, Questions 506, Virtues 508, Service 510, Games 512, Journal 514, and Special 516 that provide students with access to participate in different activities, and a small view of network map 518. Network map 518 may be the same as network map 400 in FIG. 4. By selecting tabs 502-516, the user interface enables a student to participate in activities associated with the titles of tabs 502-516. When a student selects any of tabs 502-516, a user interface displays a menu for that tab.

Window 500 is the student log in window. Window 500 also provides access to various administrative and other functions such as inviting a friend to join the network. For example, when a student selects tab Kaselehlia 502, the following menu selections appear: student log in 520, about Kaselehlia 522, administrator 524, register a school 526, preferences 528, and invite a friend 530. The user interface may display menu items as a form in the main window, as a part of the main window, as a pop-up window, or as a drop-down menu or list of items next to a menu item.

For each of the areas of activity available, the user interface provides visual feedback and feature access to the student regarding her activities or information related to an object she is viewing. Network map 518 is visible, either as in small view in some part of the activity window, or in full screen mode, such as network map 400 in FIG. 4. Full screen mode may be toggled by any method, such as mouse double-click, a software shortcut, such as Control+G, or selection by an optical selector, voice activation, or a touch screen.

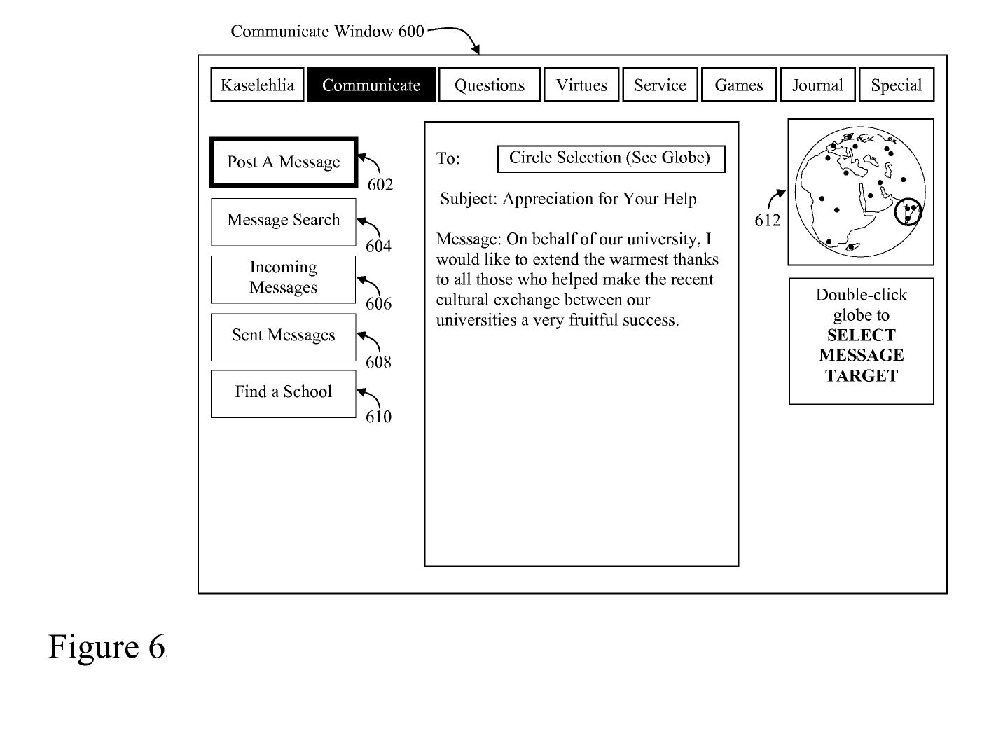

FIG. 6 is a pictorial representation illustrating a typical communicate window in accordance with an illustrative embodiment of the present invention. When a student selects communicate 504 in FIG. 5, the user interface displays communicate window 600 in FIG. 6. Using communicate window 600, students may select from menu options. A student may select post a message 602 to send a message to schools or students specified in the transparent global educational computer communication network and learn which schools or students like to discuss the subject of the message. A student may also select message search 604 to search for and retrieve communications on various subjects. Students can search the communications archives and retrieve communications by the recipient, sender, date, subject, age, geographic area, etc., for communications. After a search for a communication that matches specified search criteria, such as recipient or subject, communicate window 600 displays the search results as a list of matches for the search. Retrieving a communication means selecting a communication from a list of matches for a search and then communicate window 600 displaying the selected communication. Additionally, a student may select incoming messages 606 to read messages sent to the student in response to one of the student's previous messages and to read messages sent to the student in general. Furthermore, a student may select sent messages 608 to review messages previously sent by the student. Also, the student may select find a school 610 to find any student at a school for discussion on a specific topic. For example, if a student is studying African history, the student may select find a school 610 in order to communicate with another student at a school located in Morocco, which may be displayed by network map 612.

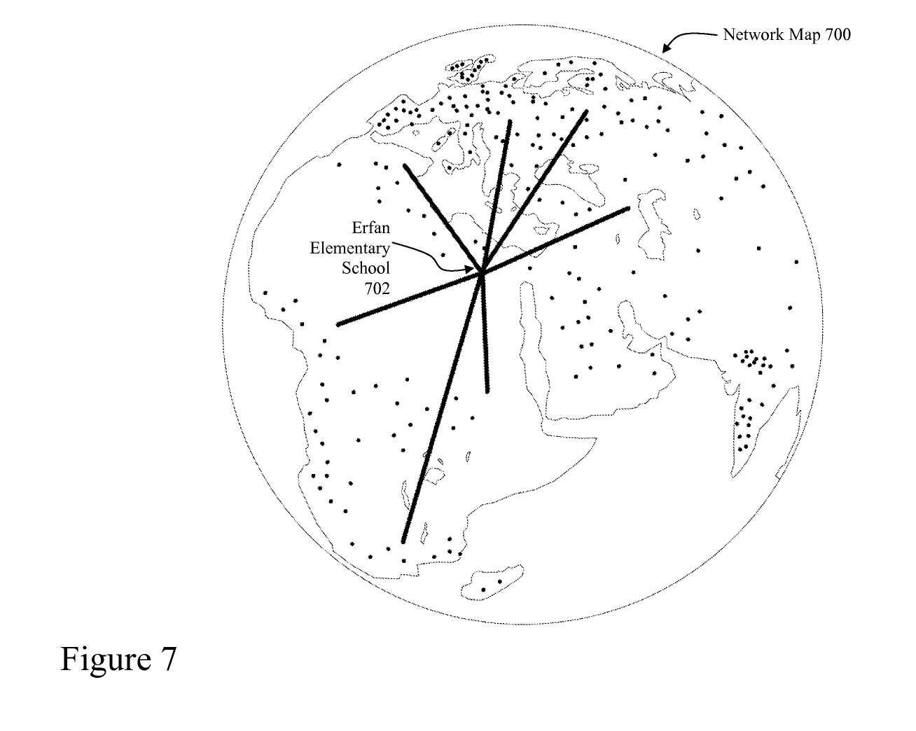

FIG. 7 is a pictorial representation illustrating a typical network map displaying various information in accordance with an illustrative embodiment of the present invention. Selecting network map 612 in FIG. 6, which may be the same as network map 518 in FIG. 5, adjusts the view of network map 612 to the activity being conducted by the student or an object of her choice. For example, as students from a school enter into communication with students at other schools, network map 700, which may be the same as network map 612 in FIG. 6, displays lines connecting the schools that are communicating with their own school 702. In an illustrative example, a student at a computer at Erfan Elementary School 702 in Egypt can see with which schools around the world the other students at Erfan are communicating by selecting a “communicating with Erfan” filter, and then clicking on network map 700. Students may also click on any school in the world to see with which other schools that particular school is communicating, and to obtain profile information for the schools. Different colored points may represent schools registered to the network, depending upon the status of the school. Lines may indicate schools associated by some activity, such as active communication, comments to a story, service project input, etc.

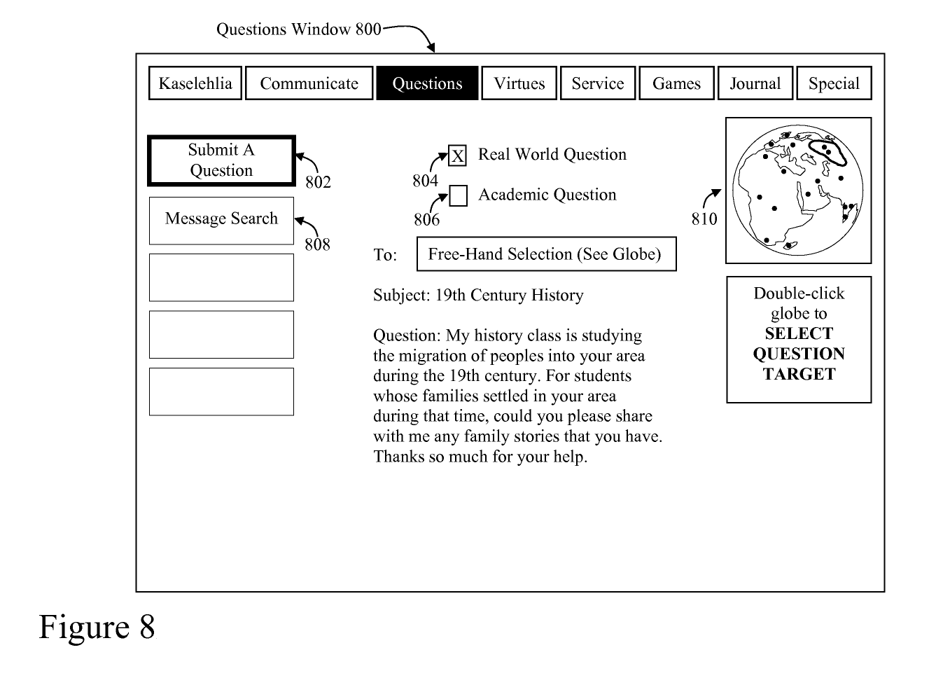

FIG. 8 is a pictorial representation illustrating a typical questions window in accordance with an illustrative embodiment of the present invention. When a student selects questions 506 in FIG. 5, the user interface displays questions window 800 in FIG. 8. Using questions window 800, students may select from menu options. A student may select submit a question 802 to submit questions to schools and students registered with the transparent global educational computer communication network, questions with options such as real world question 804 or academic question 806. A student may also select message search 808, which may be the same as message search 604 in FIG. 6.

In an illustrative example, a student in Austria who is reading a question posted by a student in Madagascar may select the network map. The user interface responds by centering the school in Madagascar where the question originates from in the view of the network map 810, which may be the same as network map 612 in FIG. 6. The student in Austria may then be interested to see from where the various responses to this question come. While viewing the responses to this question, she can select the responses, and select network map 810. The user interface responds by drawing lines from the school in Madagascar to the schools from where the responses originate.

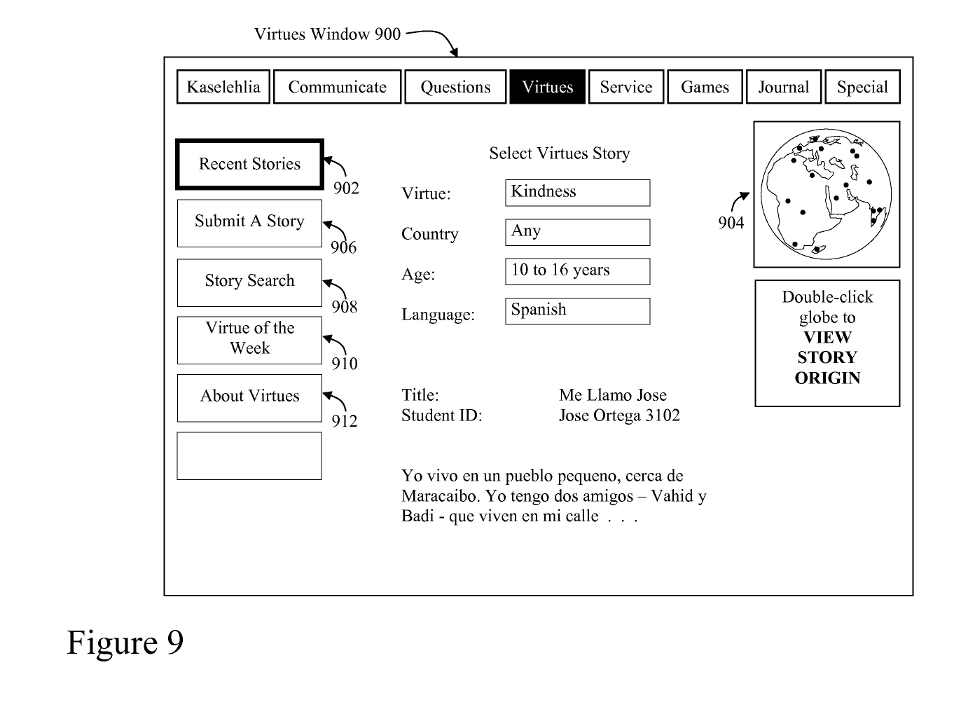

FIG. 9 is a pictorial representation illustrating a typical virtues window in accordance with an illustrative embodiment of the present invention. When a student selects virtues 508 in FIG. 5, the user interface displays virtues window 900 in FIG. 9. Virtues window 900 provides an area for students to discuss virtues and gives an overview of the importance of virtues and the development of these virtues. Using virtues window 900, students may select from menu options. A student may select recent stories 902 to view a story posted by a student. Then the student may select network map 904, which may be the same as network map 810 in FIG. 8, to see from what part of the world that story originates. The user interface may also be prompted to display the locations of students who comment on the story on network map 904. Therefore, a story originating from a school in North Africa may be seen with lines connecting the schools of students around the world who respond to that story. A student may also select submit a story 906 in order to submit a story that demonstrates a certain virtue or virtues. These stories are accessible to all schools worldwide for reflection, comment, etc. Additionally a student may select story search 908 to retrieve stories reflecting a certain virtue, stories originating from a certain school, or stories originating from a part of the world. Furthermore, a student may select virtue of the week 910 to read about the virtue written about by students most frequently during that week. Also, a student may select about virtues 912 to read about the importance of virtues and the features of virtues window 900.

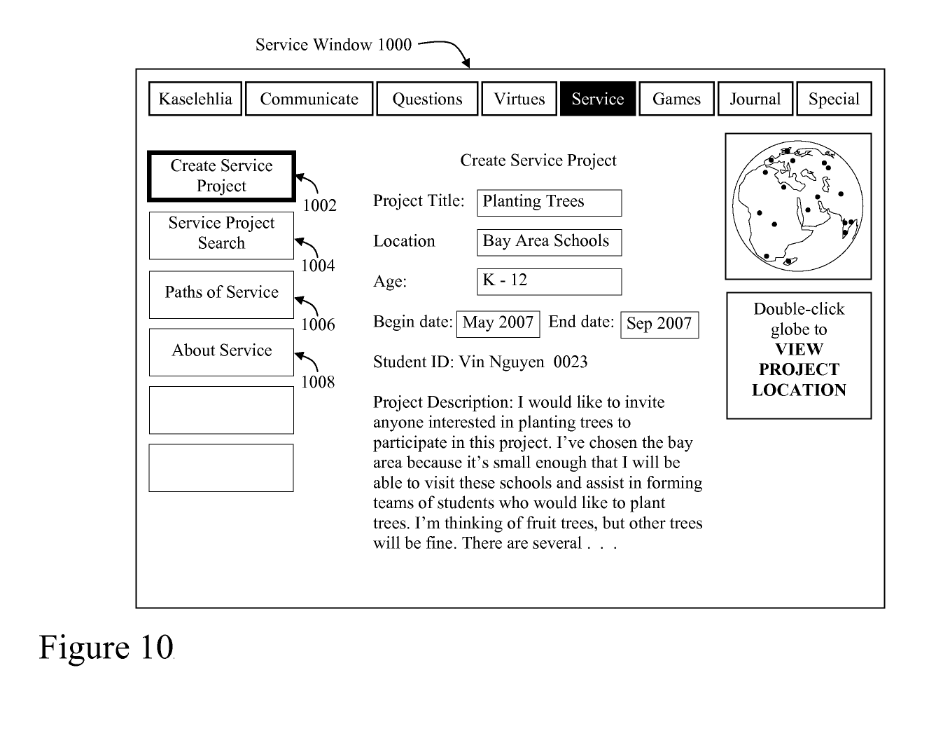

FIG. 10 is a pictorial representation illustrating a typical service window in accordance with an illustrative embodiment of the present invention. When a student selects service 510 in FIG. 5, the user interface displays service window 1000 in FIG. 10. Service window 1000 provides an area for students to explore opportunities and develop their capacity for service to their schools, communities, and projects that offer worldwide opportunities. Service window 1000 enables students to discuss paths of service, or careers, and to investigate what other people around the world do in their occupations. Using service window 1000, students may select from menu options. A student may select create service project 1002 to suggest a service project for their school, local community or greater community, and invite others to participate. Additionally, a student may select service project search 1004 to research what kinds of service projects are ongoing in her area. Furthermore, a student may select paths of service 1006 to learn about what career opportunities are related to a particular path of service. Also, a student may select about service 1008 to learn about the importance of developing the capacity to serve others.

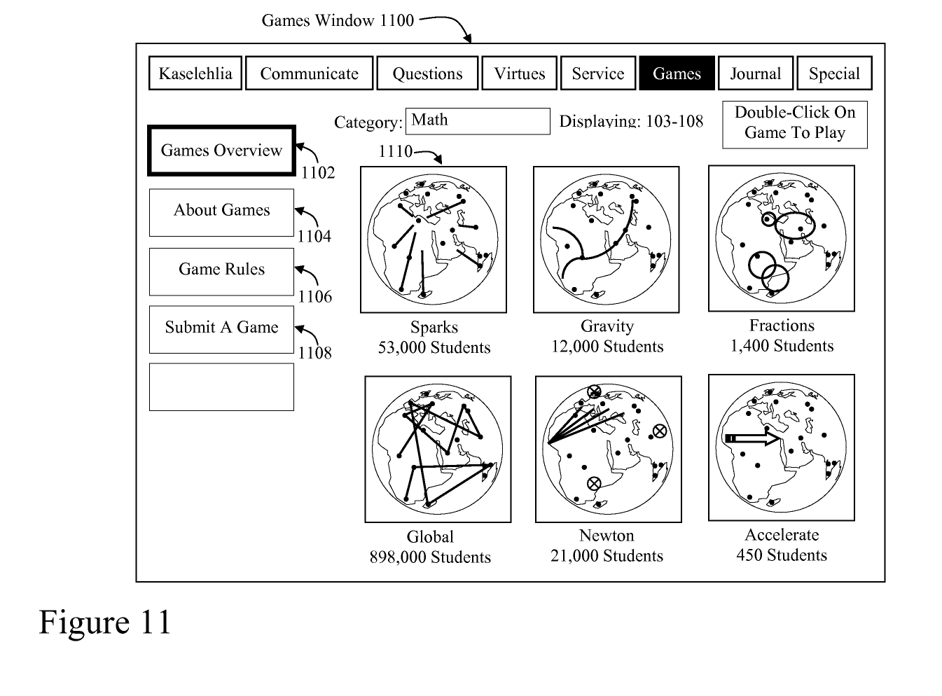

FIG. 11 is a pictorial representation illustrating a typical games window in accordance with an illustrative embodiment of the present invention. When a student selects games 512 in FIG. 5, the user interface displays games window 1100 in FIG. 11. Games window 1100 provides an area to play games that are fun, have a positive message, and build skills, with fellow students all over the world. There are no competing teams in these games. Students cooperate to reach a common beneficial goal. Network maps provide game interaction and animation. Using games window 1100, students may select from menu options. A student may select games overview 1102 to have an overview of available games. Additionally, a student may select about games 1104 to learn about the purpose for the games offered to the student. Furthermore, a student may select games rules 1106 to learn the specific rules pertaining to a game that she has selected. Also, a student may select submit a game 1108 to suggest a game that may be developed for the transparent global educational computer communications network.

An illustrative example of a game available through games window 1100 is Sparks. The purpose of Sparks is to help students learn how to solve simultaneous equations, while interacting and cooperating with other students around the world. When a student logs in to play Sparks, five sparks are automatically sent out from his school to the schools of five other students, in different parts of the world, who are playing the game at the time. Network map 1110 displays the path, position, and direction of these sparks.

Each student who enters the game automatically generates five sparks that travel to the school locations of five different students around the world. Therefore, at any one time a number of sparks are traveling towards their destinations, generated by the students who have just begun to play Sparks. If a spark reaches the destination for the spark (the destination being a school location for another student playing the game), five additional sparks are generated from that location. Consequently, as students begin to play the game, and sparks reach their destinations, the number of sparks in the game grows. For example, if one spark is allowed to reach its destination, this spark will generate five additional sparks. If these five additional sparks each reach their destinations, they will generate twenty-five additional sparks, and so on. The object of the game is to “capture” the sparks before they reach their destination in order to prevent the number of sparks from multiplying. In order to capture a spark, a student sends out a “captor” from his own school to overtake the spark at a specified place along the spark's path. This specified place is randomly generated by the game for each spark. To capture a spark, the student must send the captor with the correct velocity and at the correct time. In order to calculate the correct velocity and correct time, the student must solve two simultaneous equations. One equation describes the position of the spark with respect to time, and the other equation describes the position of the captor with respect to time. If the captor overtakes the spark either too early in the spark's path, or too late in the spark's path, the captor will not capture the spark, and the spark may reach its destination and multiply into five additional sparks. If the population of sparks is not controlled, the number of sparks will become so great and increase so rapidly that it becomes impossible for the students to capture all the sparks, such that the sparks “win” the game. When the student begins to play Sparks, he will see five lines originating from his school and connecting with five other schools. Each spark is displayed along its line as a blinking point of light. The student may select a spark to get the information regarding the start time of the spark, the present velocity of the spark, the capture point of the spark, the name of the receiving student, etc. For a given spark, the sending and receiving students may communicate with one another regarding the capture of the spark. Either the sending or receiving student may capture the spark. The two students may decide on who will capture the spark, or if they will both attempt to capture the spark. A student may view outgoing sparks (sparks that are generated from his school's location), incoming sparks (sparks that are being directed towards his school's location), or he may view all sparks.

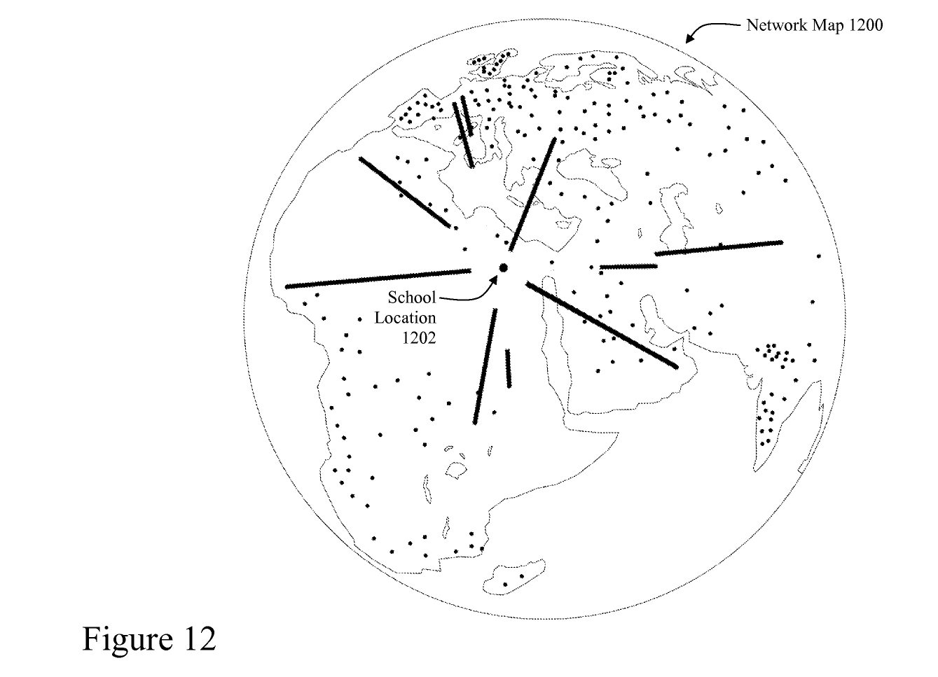

FIG. 12 is a pictorial representation illustrating a typical network map displaying an animation feature in accordance with an illustrative embodiment of the present invention. In an illustrative example, network map 1200 displays an animation feature from the interactive game Sparks. Network map 1200 displays lines representing sparks originating from different schools and traveling toward the school location 1202 of a student playing the game.

In order to offer a variety of network maps, and in some cases as part of the games themselves, some games can also be played with “overlays”. For example, the game Sparks, described above, may be played with the network map representing the earth, or it may be played with an overlay of an “earth twin.” An earth twin is a fictitious planet in which there are continents and oceans, but continents and oceans that do not match those of earth. For example, a student located in Melbourne, Australia, may be tired of playing all of her games from that location, and may, for the games for which an earth twin is available, play the game using the earth twin overlay, and choose the location from which she would like to play.

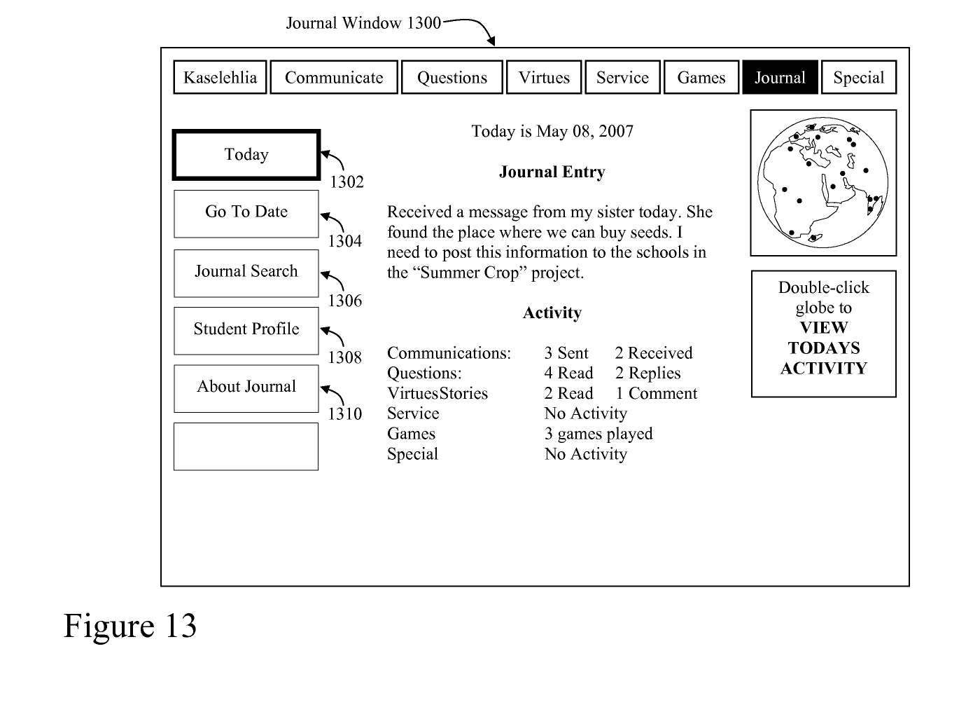

FIG. 13 is a pictorial representation illustrating a typical journal window in accordance with an illustrative embodiment of the present invention. When a student selects journal 514 in FIG. 5, the user interface displays journal window 1300 in FIG. 13. Journal window 1300 provides a personal journal for students to write journal entries. A student may use the journal to write notes about whatever the student is learning about. The journal is a private journal that is accessed by password only and is not accessible to others. The journal is organized by calendar days. The user interface automatically logs certain information regarding the student's activities, such as stories responded to, what subjects were discussed, with whom the student communicated, what games were played, etc. Therefore, a student may look back in her journal to see what he has written, and what activities she participates in on any particular day. Using journal window 1300, students may select from menu options. A student may select today 1302 to review the activities of the current date. Additionally, a student may select go to date 1304 to learn what activities she participates in on a certain date. Furthermore, a student may select journal search 1306 to retrieve a certain journal text entry. Also, a student may select student profile 1308 to complete and submit an optional student profile, which includes such information as name, place of birth, languages spoken, year of birth, courses of study, space for a personal message, etc. Such a student profile is available for viewing by other students worldwide. Moreover, a student may select about journal 1310 to learn about the features of journal window 1300.

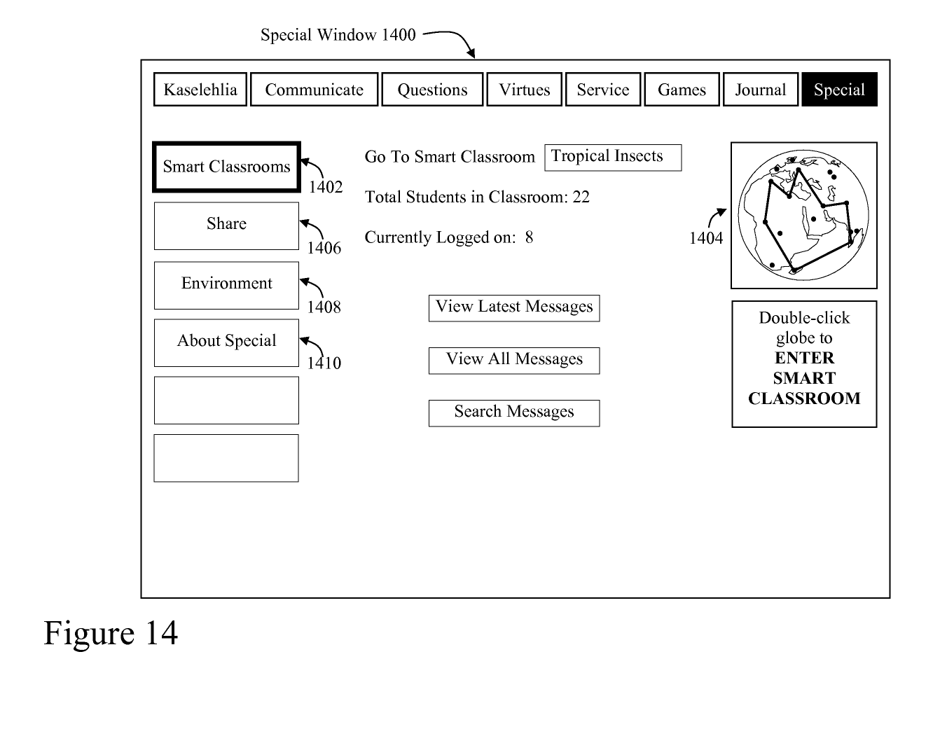

FIG. 14 is a pictorial representation illustrating a typical special window in accordance with an illustrative embodiment of the present invention. When a student selects special 516 in FIG. 5, the user interface displays special window 1400 in FIG. 14. Using special window 1400, students may select from menu options. A student may select smart classrooms 1402 to form a “Smart” or virtual classroom that transcend schools, age, grades, and geography. Smart Classrooms may be formed based a course of study, research of a specific question, a path of service, a service project, or any area of interest that would associate a group of students. The student initiating the smart classroom may set a limit on the number of students in the smart classroom, such as 20 students, and then invite students from around the world to join. Students in the smart classroom may post certain information to the smart classroom, etc. Network map 1404, which may be the same as network map 904 in FIG. 9, displays the smart classroom, who is connected to the smart classroom, who posts messages to the smart classroom, etc.

Additionally, a student may select share 1406 in order to discuss the possibility of sharing school supplies. Share 1406 offers a way for resources that might otherwise go to waste to be distributed for useful purposes. For example, many school laboratories have excess or expired chemicals that have to be disposed, sometimes at a high cost. An inventory of these chemicals may be posted on share 1406 for possible use by other schools that could use them. Furthermore, a student may select environment 1408 to provide a way for schools to register various environmental data relating to their location. For example, a school may record the daily amount of rainfall, temperature, barometric pressure, relative humidity, cloud cover, etc. and keep a log of this data on an environment page. All such data can be automatically uploaded by the user interface to the transparent global educational computer communication network server and can be searchable by all other schools registered to the network. Also, a student may select about special 1410 to learn about the various features of special window 1400.

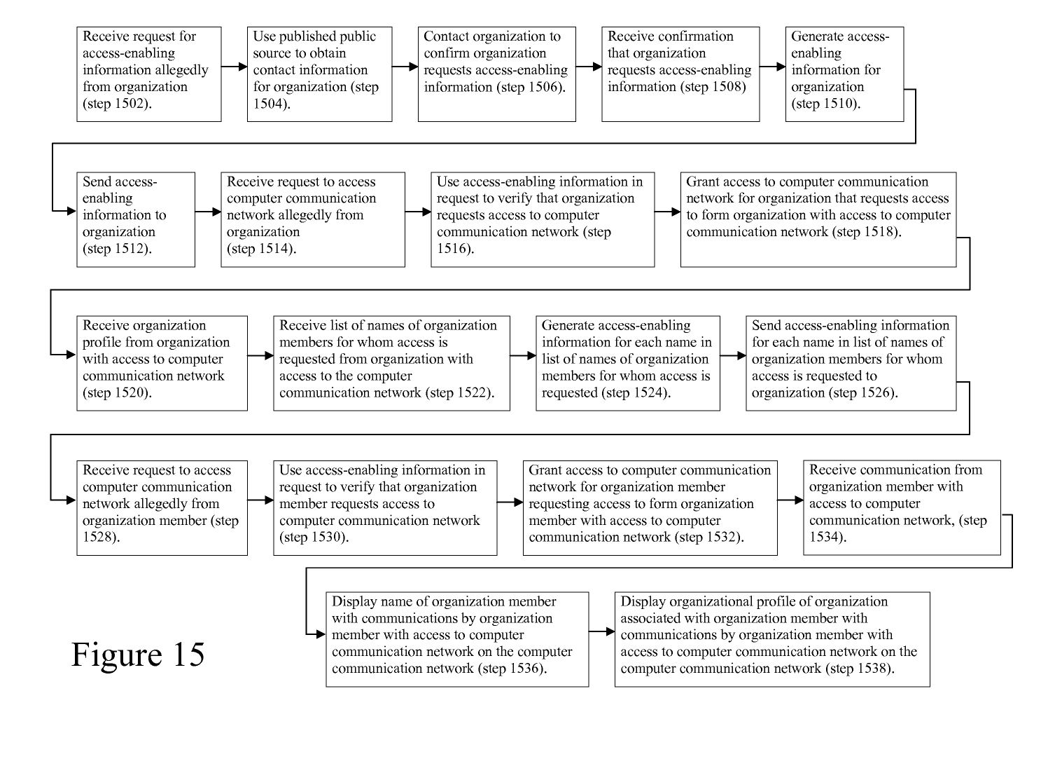

FIG. 15 is a flow chart illustrating a typical network process in accordance with an illustrative embodiment of the present invention. A computer communication network server receives a request for access-enabling information allegedly from an organization, submitted by an alleged organization administrator (step 1502). The request for access-enabling information may be a standard form that specifies the organization name, address, and the name of the organization administrator that submits the request. Additionally, the request for access-enabling information may include an organization profile. Also, the request for access-enabling information may include a list of names of organization members for whom access is requested. The alleged organization administrator may use a user interface to submit the request for access-enabling information on behalf of the organization through a computer communication network. Alternatively, the alleged organization administrator may submit the request for access-enabling information on behalf of the organization through other means, such as electronic mail, postal mail, or a telephone call. If the computer communication network server receives the request for access-enabling information through other means such as postal mail or a telephone call, a computer communication network administrator enters the request for access-enabling information into the computer communication network server. The computer communication network server directly receives a request for access-enabling information submitted by electronic mail.

Then, the computer communication network server uses a published public source to obtain contact information for the organization (step 1504). The computer communication network server may access a database to obtain contact information from the published public source.

Next, the computer communication network server contacts the organization to confirm that the organization requests access-enabling information (step 1506). The computer communication network server may send an electronic mail to an electronic mail address specified for the organization in the published public source. The electronic mail sent to an electronic mail address specified for the organization may request the organization administrator that has access to the electronic mail address specified for the organization to confirm the organization requests access-enabling information by responding to the electronic mail sent by the computer communication network server in a particular way. If the published public source does not specify an electronic mail address for the organization, the computer communication network server may confirm that the organization requests access-enabling information by prompting a computer communication network administrator to use a published public source to contact the organization and confirm that the organization requests access-enabling information. The computer communication network administrator may contact the organization by telephone, postal mail, or any other means.

After that, the computer communication network server receives confirmation that the organization requests access-enabling information (step 1508). The organization may confirm that the organization requests access-enabling information by responding to the electronic mail sent by the computer communication network server in a particular way. Alternatively, the organization may confirm that the organization requests access-enabling information through the computer communication network administrator, who enters the confirmation in the computer communication network server. If the computer communication network server does not receive confirmation that the organization requests access-enabling information, the computer communication network server terminates the process for the request for access-enabling information.

If the computer communication network server receives confirmation that the organization requests access-enabling information, the computer communication network server generates access-enabling information for the organization (step 1510). The access-enabling information may include organization identification characters and an organization password that enable the organization administrator to access the computer communication network.

Subsequently, the computer communication network server sends access-enabling information to the organization, through the organization administrator (step 1512). If the organization administrator specifies a list of names of organization members for whom access is requested in the request for access-enabling information, the access-enabling information may include individualized organization member identification characters and a temporary individualized organization member password for each organization member specified in the list of names of organization members for whom access is requested.

Then, the computer communication network server receives a request to grant access to the computer communication network allegedly from the organization, submitted by an alleged organization administrator, wherein the request to grant access includes access-enabling information (step 1514). The access-enabling information may include organization identification characters and an organization password to enable an organization administrator to access the computer communication network.

Next, the computer communication network server uses the access-enabling information in the request to verify that the organization requests access to the computer communication network (step 1516). If the computer communication network server does not verify that the organization requests access to the computer communication network, the computer communication network server does not grant access to the computer communication network for the request to grant access allegedly from the organization.

If the computer communication network server verifies that the organization requests access to the computer communication network, the computer communication network server grants access to the computer communication network for the organization that requests access to form an organization with access to the computer communication network (step 1518). After that, the computer communication network server may receive an organization profile from the organization with access to the computer communication network, submitted by the organization administrator for the organization with access to the computer communication network (step 1520). The organization profile may include information about the organization that the organization decides to display in association with communications by organization members, such as the name and the geographic location of the organization.

Also, the computer communication network server may receive a list of names of organization members for whom access is requested from the organization with access to the computer communication network, submitted by the organization administrator for the organization with access to the computer communication network (step 1522). The list of names of organization members for whom access is requested may be a comprehensive list of names of organization members for whom access is requested if the organization administrator has not already submitted a list of names of organization members for whom access is requested. A comprehensive list of names of organization members for whom access is requested may include the names of each organization member for whom access is requested. The list of names of organization members for whom access is requested may be a revised list of names of organization members for whom access is requested if the organization administrator has already submitted a list of names of organization members for whom access is requested. A revised list of names of organization members for whom access is requested may include the names of each organization member for whom access is already requested, the names of each organization member for whom access is currently being requested, and the names of each organization member for whom access is no longer requested.

Subsequently, the computer communication network server generates access-enabling information, that may include individualized organization member access-enabling information, for each name in the list of names of organization members for whom access is requested (step 1524). The individualized organization member access-enabling information may include individualized organization member identification characters and a temporary individualized organization member password.

Then, the computer communication network server sends the access-enabling information, that may include individualized organization member access-enabling information, for each name in list of names of organization members for whom access is requested to the organization, through the organization administrator (step 1526). The organization administrator may convey the individualized organization member access-enabling information to each organization member listed by name in the list of names of organization members for whom access is requested. The individualized organization member access-enabling information may include individualized organization member identification characters and a temporary individualized organization member password for each organization member listed by name in the list of names of organization members for whom access is requested. Each organization member listed by name in the list of names of organization members for whom access is requested may use individualized organization member access-enabling information to access the computer communication network via a user interface.

Next, the computer communication network server receives a request to access the computer communication network allegedly from an organization member, wherein the access request includes access-enabling information (step 1528). A request to access a computer communication network is a formal message expressing the desire to use the computer communication network. The access-enabling information may include individualized organization member identification characters and an individualized organization member password to enable an organization member to access the computer communication network.

After that, the computer communication network server uses the access-enabling information in the request to verify that the organization member requests access to the computer communication network (step 1530). If the computer communication network server does not verify that the organization member requests access to the computer communication network, the computer communication network server does not grant access to the computer communication network for the request to access the computer communication network allegedly from the organization member. An organization member other than the alleged organization member may submit the request to access the computer communication network. An other organization member may be an other member of the organization or a member of an other organization.

If the computer communication network server verifies that the organization member requests access to the computer communication network, the computer communication network server grants access to the computer communication network for the organization member requesting access to form an organization member with access to the computer communication network (step 1532). Afterwards, an organization member with access to the computer communication network has an option to change the temporary individualized organization member password for the organization member, which is known by the organization administrator, to an individualized organization member password for the organization member, which is known only to the organization member.

Subsequently, the computer communication network server receives a communication from an organization member with access to the computer communication network, (step 1534). Then, the computer communication network server displays the name of an organization member with communications from the organization member with access to the computer communication network on the computer communication network (step 1536). Displaying the name of the organization member means displaying the given name and family name of the organization member submitted by the organization, not an alias selected by the organization member. To display the name of an organization member with communications from the organization member on the computer communication network means to make the combination of the name and the communications available for display, searching, and retrieving by registered users of the computer communication network. Displaying a name of the organization member with the communication from the organization member on the computer communication network may include displaying the name with the communication on a computer communication network map. Also, the computer communication network server may display the organizational profile of the organization associated with an organization member with communications by the organization member with access to the computer communication network on the computer communication network (step 1538).

The invention can take the form of an entirely software embodiment or an embodiment containing both hardware and software elements. In an illustrative embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and digital video disc (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the embodiments of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for a computer communication network, the computer implemented method comprising:
using a published public source to confirm that an organization requests access-enabling information;
in response to confirming that the organization requests access-enabling information, sending the access-enabling information to the organization;
using the access-enabling information to verify that an organization member requests access to the computer communication network;
in response to verifying that the organization member requests access to the computer communication network, receiving a communication from the organization member; and
displaying a name of the organization member with the communication from the organization member on the computer communication network.

2. The computer implemented method of claim 1, further comprising:
displaying an organizational profile of the organization with the communication from the organization member on the computer communication network.

3. The computer implemented method of claim 1, further comprising:
searching for and retrieving the communication from the organization member on the computer communication network.

4. The computer implemented method of claim 1, further comprising:
providing a game for the organization member to play on the computer communication network with an other organization member.

5. The computer implemented method of claim 1, wherein displaying the name of the organization member with the communication from the organization member on the computer communication network comprises displaying the name of the organization member with the communication from the organization member on a computer communication network map.

6. The computer implemented method of claim 5, wherein recipients of the communication are selected directly from the computer communication network map.

7. The computer implemented method of claim 5, wherein the computer communication network map displays information about network activity statuses.

8. A data processing system for a computer communication network, comprising:
a bus,
a storage device connected to the bus, wherein the storage device contains computer usable code;
a communications unit connected to the bus; and
a processing unit connected to the bus, wherein the processing unit executes the computer usable code to use a published public source to confirm that an organization requests access-enabling information, send the access-enabling information to the organization, in response to confirming that the organization requests access-enabling information, use the access-enabling information to verify that an organization member requests access to the computer communication network, receive a communication from the organization member, in response to verifying that the organization member requests access to the computer communication network, and display a name of the organization member with the communication from the organization member on the computer communication network.

9. The data processing system of claim 8, further comprising computer usable code to display an organizational profile of the organization with the communication from the organization member on the computer communication network.

10. The data processing system of claim 8, further comprising computer usable code to search for and retrieve the communication from the organization member on the computer communication network.

11. The data processing system of claim 8, further comprising computer usable code to provide a game for the organization member to play on the computer communication network with an other organization member.

12. The data processing system of claim 8, wherein computer usable code to display the name of the organization member with the communication from the organization member on the computer communication network comprises computer usable code to display the name of the organization member with the communication from the organization member on a computer communication network map.

13. The data processing system of claim 12, wherein recipients of the communication are selected directly from the computer communication network map.

14. The data processing system of claim 12, wherein the computer communication network map displays information about network activity statuses.

15. A computer program product for a computer communication network, the computer program product comprising:
a computer usable medium having computer usable program code embodied therein;
computer usable program code configured to use a published public source to confirm that an organization requests access-enabling information;
computer usable program code configured to send the access-enabling information to the organization, in response to confirming that the organization requests access-enabling information;
computer usable program code configured to use the access-enabling information to verify that an organization member requests access to the computer communication network;
computer usable program code configured to receive a communication from the organization member, in response to verifying that the organization member requests access to the computer communication network; and
computer usable program code configured to display a name of the organization member with the communication from the organization member on the computer communication network.

16. The computer program product of claim 15, further comprising computer usable code configured to display an organizational profile of the organization with the communication from the organization member on the computer communication network.

17. The computer program product of claim 15, further comprising computer usable code configured to search for and retrieve the communication from the organization member on the computer communication network.

18. The computer program product of claim 15, further comprising computer usable code configured to provide a game for the organization member to play on the computer communication network with an other organization member.

19. The computer program product of claim 15, wherein computer usable code configured to display the name of the organization member with the communication from the organization member on the computer communication network comprises computer usable code configured to display the name of the organization member with the communication from the organization member on a computer communication network map.

20. The computer program product of claim 19, wherein recipients of the communication are selected directly from the computer communication network map.
